(19) United States
(12) Patent Application Publication
(10) Pub. No.: US 2009/0300613 A1
(43) Pub. Date: Dec. 3, 2009

(54) INPUT/OUTPUT EMULATION SYSTEM FOR VIRTUAL MACHINE

(75) Inventor: Tsunehisa Doi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/472,847

(22) Filed: May 27, 2009

(30) Foreign Application Priority Data
May 27, 2008 (JP) 2008-138178

(51) Int. Cl. G06F 9/455

(52) U.S. Cl. 718/1

(57) ABSTRACT

An I/O emulation system for a virtual machine includes a command interpretation portion including a programmable logic device that detects completion of a plurality of device operating instructions, which corresponds to a device operating request for the virtual machine, output from the guest device driver included, a device control portion that converts the plurality of device operating instructions, which is notified by a virtual machine monitor, into an I/O command and a host device driver that outputs a device operating instruction for the actual device in accordance with the I/O command.

### CROSS-REFERENCE TO RELATED APPLICATION

This application is based upon and claims the benefit of priority of the prior Japanese Patent Application No. 2008-138178, filed on May 27, 2008, the entire contents of which are incorporated herein by reference.

### FIELD

The invention relates to an input/output (I/O) emulation system for a guest virtual machine (VM) used in a VM environment of a computer system.

### BACKGROUND

Conventionally, there is known a system that provides a VM environment using a guest operating system (OS) (guest VM) on a computer system. Specifically, there is known a system that provides, through virtual machine emulation processing on a computer, the same environment as in a case where the computer is provided with a virtual machine. In such a computer system, I/O emulation for the guest VM employs a mechanism in which a memory access instruction with respect to a memory mapped input/output (MMIO) region (device operating instruction with respect to virtual device) is intercepted by a hypervisor to perform the emulation.

FIG. 4 is a general explanatory diagram for conventional device emulation. As illustrated in FIG. 4, on a computer, there is provided a host OS 51 and a guest OS 52. A virtual machine monitor 53 called “hypervisor” mediates between the host OS 51 and the guest OS 52. The guest OS 52 includes one or more applications 54 for realizing a virtual machine. When the application 54 accesses an actual device, the following processing is executed.

Specifically, when a device access request is issued from the application 54 of the guest OS 52, a device driver 55 provided to the guest OS 52 outputs low-level device operating instructions with respect to a virtual device corresponding to the device access request. Then, the hypervisor 53 intercepts all the low-level device operating instructions output from the device driver 55, and then transfers the intercepted device operating instructions to an emulator 56 (called “device model”), which is device hardware and is provided to the host OS 51. This transfer is executed as access exception processing.

The emulator 56 converts the low-level device operating instructions transferred from the hypervisor 53 into a device operating instruction (command) with respect to the actual device, and then provides the converted device operating instruction to a device driver 57 in the host OS 51. The device driver 57 can access the actual device in accordance with the command.

FIG. 5 illustrates the conventional emulator 56 illustrated in FIG. 4. The emulator 56 includes a command interpretation automaton 61, a device state retention/storage portion 62, and a device control portion (command issue portion) 63, which execute MMIO emulation.

The command interpretation automaton 61 performs interpretation of device operating instructions with finer granularity, such as a load instruction and a store instruction, issued from a processor (guest OS). When such device operating instructions with finer granularity are completed as one set of a device operating instruction with coarse granularity (are interpreted as emulation code), the command interpretation automaton 61 requests the device control portion 63 to issue a command corresponding to this emulation code.

The device state retention/storage portion 62 retains an in-progress state of interpretation of device operating instructions which is performed by the command interpretation automaton 61, contents of instructions given thus far from the guest OS 52 with respect to hardware (actual device), and a result of access to the actual device.

The device control portion 63 actually issues the command that is completed as a device operating instruction to the device driver 57, and obtains a result thereof from the device driver 57. The device control portion 63 is capable of reflecting a result of actual operation in the device state retention/storage portion 62.

In the prior art described above, there is employed a method in which device operating instructions with finer granularity output from the device driver 55 of the guest OS 52 are all intercepted and transmitted to the emulator 56, whereby the emulator 56 calls an emulation code. The method described above requires a considerably larger length of time compared with an operation executed by a normal memory access instruction, that is an operation to access an actual device performed by a host OS.

### SUMMARY

One of aspects of an input/output (I/O) emulation system for a virtual machine includes:

a guest operating system including a guest device driver configured to output a plurality of device operating instructions for a virtual device that corresponds to a device operating request from an application of the virtual machine;

a command interpretation portion configured to detect the plurality of device operating instructions output from the guest device driver, the command interpretation portion including a programmable logic device;

a host operating system including a device control portion configured to convert the plurality of device operating instructions detected by the command interpretation portion into an I/O command for an actual device to issue the I/O command and a host device driver configured to output a device operating instruction for the actual device in accordance with the I/O command issued from the device control portion; and

a virtual machine monitor that mediates between the guest operating system and the host operating system and includes a notification portion configured to notify the device control portion of the host operating system of the plurality of device operating instructions detected by the command interpretation portion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a configuration example of an I/O emulation system for a virtual machine;

FIG. 2 is a diagram illustrating an operation example of the I/O emulation system illustrated in FIG. 1;

FIG. 3 is a diagram illustrating a modification example of the I/O emulation system illustrated in FIG. 1;

FIG. 4 is a diagram illustrating a conventional I/O emulation system; and

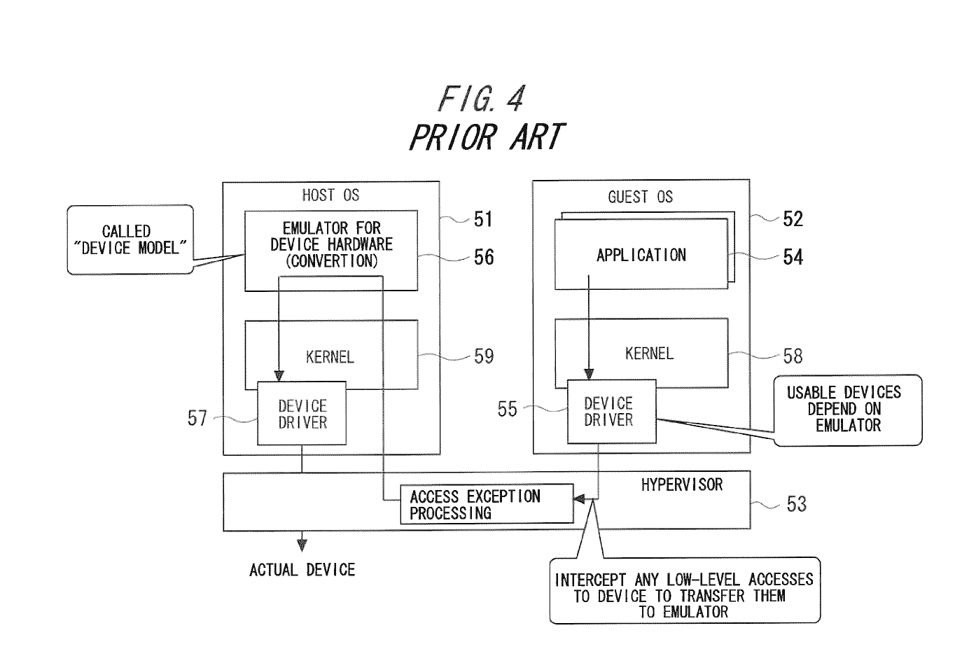

FIG. 5 is a diagram illustrating a configuration of an emulator illustrated in FIG. 4.

### DESCRIPTION OF EMBODIMENTS

Hereinafter, an embodiment of an I/O emulation system for a virtual machine is described with reference to the drawings. A configuration of the embodiment described below is one example.

In the embodiment, an MMIO emulation device which uses a programmable logic device (PLD) such as a field programmable gate array (FPGA) is provided to a VM system run by a guest OS.

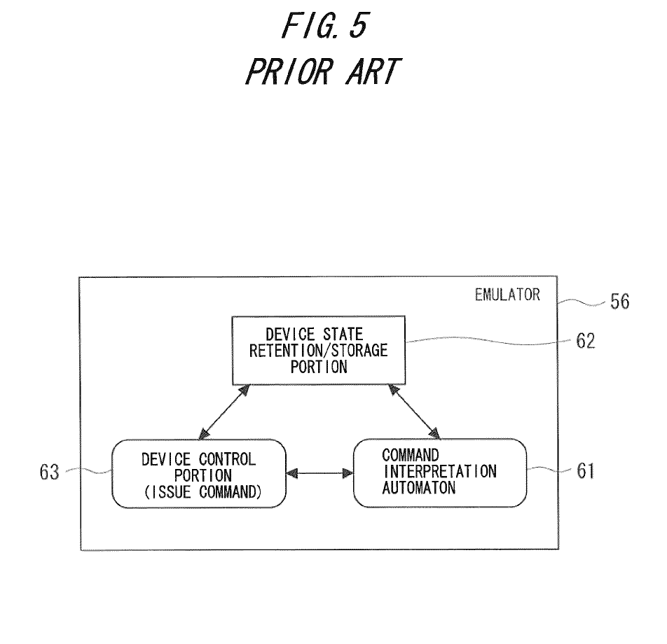

Specifically, in the embodiment, a command interpretation automaton portion (61 of FIG. 5) for MMIO emulation is realized with such a PLD as the FPGA. The command interpretation automaton may be realized with hardware called memory based logic (MBL) instead of the FPGA.

According to the embodiment, upon detection of completion of a plurality of device operating instructions (for example, a series of device operating instructions) with lower granularity (corresponding to one I/O command) which are output from a device driver (guest device driver) of the guest OS, the command interpretation automaton (MMIO emulation device) realized with the PLD notifies MMIO emulation software of this. This notification may be carried out using various methods including interrupt processing and polling.

It should be noted that, when such processing that only changes an internal state of the MMIO emulation device (command interpretation automaton) is performed, this change is not notified to the MMIO emulation software.

After detecting the completion of the plurality of device operating instructions, and ending the notification processing therefore, the MMIO emulation device (command interpretation automaton) shifts the internal state of the MMIO emulation device and a state of the memory into an end state, and then ends the MMIO emulation.

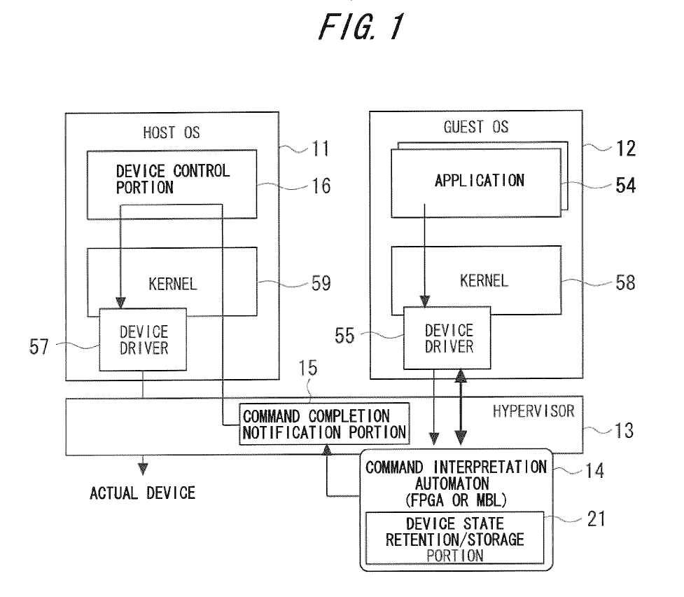

FIG. 1 is a diagram illustrating a configuration example of the I/O emulation system (MMIO emulation system) for a virtual machine according to the embodiment. In FIG. 1, the I/O emulation system includes a host OS 11, a guest OS 12 for realizing a virtual machine, a hypervisor 13 as a virtual machine monitor that mediates between the host OS 11 and the guest OS 12, and a command interpretation automaton (corresponding to a command interpretation portion) 14 as the MMIO emulation device.

The guest OS 12 includes one or more applications 54, a kernel (native kernel) 58, and a device driver (corresponding to a guest device driver) 55. A memory access instruction, that is device operating instruction with finer granularity, issued from the device driver 55 is input to the command interpretation automaton 14.

The hypervisor 13 includes a command completion notification portion 15 connected to the command interpretation automaton 14. The host OS 11 includes a device control portion (MMIO emulation software) 16 connected to the command completion notification portion 15, a kernel (para kernel) 59, and the device driver (host device driver) 57.

Here, the command interpretation automaton 14 is created using the FPGA or the MBL. Further, the command interpretation automaton 14 may include a device state retention/storage portion 21. The device state retention/storage portion 21, which corresponds to a device state retention/storage portion 62 illustrated in FIG. 5, is capable of retaining an in-progress state of interpretation of device operating instructions which is performed by the command interpretation automaton 14, contents of instructions given thus far from the guest OS 12 with respect to hardware (actual device), and a result of access to the actual device.

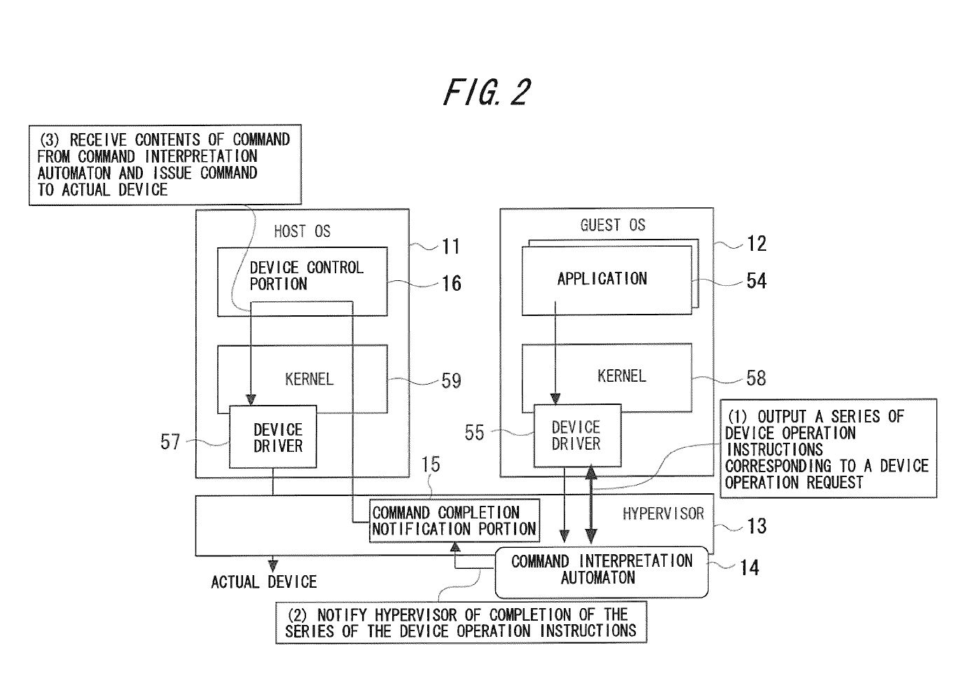

FIG. 2 is an operation explanatory diagram for the MMIO emulation system illustrated in FIG. 1. Referring to FIG. 2, when a device access request is issued from the application 54 of the guest OS 12, the device access request is provided to the device driver 55 via the kernel 58, and the device driver 55 outputs a plurality of device operating instructions (memory access instructions) corresponding to the device access request. The plurality of device operating instructions is a plurality of device operating instructions with finer granularity, such as store instruction and load instruction. The plurality of device operating instructions output from the device driver 55 is input to the command interpretation automaton 14 ((1) of FIG. 2). The plurality of device operating instructions is memory access instructions for a virtual machine realized by the guest OS 58. The operation thus far is the same as operation to a native hardware.

Upon completion of the plurality of the device operating instructions from the device driver 55, the command interpretation automaton 14 detects the completion to notify the command completion notification portion 15 of the completion of the plurality of device operating instructions ((2) of FIG. 2). For example, upon completion of outputting of continuous device operating instructions from the device driver 55, the command interpretation automaton 14 interprets the continuous device operating instructions as the plurality of device operating instructions corresponding to one I/O command, and notifies the command completion notification portion 15 of the hypervisor 13 of the completion of the plurality of device operating instructions. At this point, the device state retention/storage portion 21 included in the command interpretation automaton 14 can retain data such as an in-progress result of the interpretation.

The command completion notification portion 15 notifies, through, for example, the interrupt processing, the device control portion 16 of the host OS 11 of the completion of the device operating instructions and the plurality of device operating instructions. At this point, the command interpretation automaton 14 may interpret the plurality of device operating instructions as one I/O command, and notify the device control portion 16 of an issue request for the I/O command via the command completion notification portion 15.

The device control portion 16, which is identical to a device control portion 63 of an emulator 56 according to the prior art, converts the plurality of device operating instructions obtained from the command completion notification portion 15 into an I/O command (namely, emulation code) in accordance with the actual device, and then outputs the I/O command.

The I/O command is provided to the device driver 57 via the kernel 59, and the device driver 57 outputs at least one device operating instruction (device operating command) corresponding to the I/O command to access the actual device. In this manner, access to the actual device in accordance with the device access request from the application 54 is performed.

After that, the device driver 57 receives a result of the access to the actual device, and the result of the access is converted into a format appropriate for the application 54 of the guest OS 12 (for the virtual device recognized by the application 54 of the guest OS 12) by the device control portion 16 and then provided to the device driver 55 via the hypervisor 13. The result of the access is provided to the application 54 from the device driver 55 via the kernel 58. In the course of this process, data of the result of the access is stored in the device state retention/storage portion 21 provided in the command interpretation automaton 14.

According to the I/O emulation system described above, the command interpretation automaton 14 realized with the hardware that uses the FPGA or the MBL detects the completion of the plurality of device operating instructions output from the device driver 55. Accordingly, compared with such a case as in the prior art in which a hypervisor 53 notifies device operating instructions from a device driver, and a command interpretation automaton 61 provided in the emulator 56 interprets the device operating instructions through software processing, it is possible to achieve a considerable time reduction. As a result, it is possible to reduce the length of time required for I/O emulation processing and thus for the guest OS 12 (application 54) to access the actual device, whereby the speedup (performance improvement) of the virtual machine can be achieved.

Specifically, according to the embodiment, in the VM system, an overhead that is imposed on the MMIO emulation of the guest VM (guest OS 12) is reduced, and therefore the speedup of the processing can be achieved. Normally, in the MMIO emulation, the speedup is achieved by implementing a device driver dedicated to a VM system. Instead of implementing such a dedicated device driver, with the application of a general-purpose device driver such as the device driver 55, it is possible to speed up the device access.

Further, owing to the application of a PLD such as the FPGA, it is possible to create all kinds of MMIO emulation devices, which results in high extensibility and versatility.

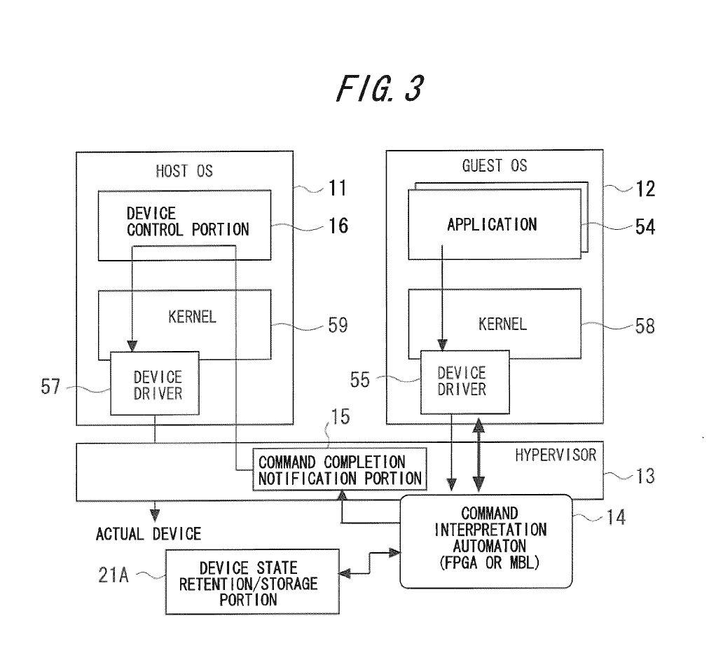

Further, in the example illustrated in FIG. 1, a case in which the device state retention/storage portion 21 is provided in the command interpretation automaton 14 is described, but it is also possible to provide the device state retention/storage portion 21 in a main memory (not shown) (see device state retention/storage portion 21A of FIG. 3).

The configuration according to the embodiment described above can be appropriately combined within the scope which does not depart from the object of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An input/output emulation system for a virtual machine, comprising:
a guest operating system including a guest device driver configured to output a plurality of device operating instructions for a virtual device that corresponds to a device operating request from an application of the virtual machine;
a command interpretation portion configured to detect the plurality of device operating instructions output from the guest device driver, the command interpretation portion including a programmable logic device;
a host operating system including a device control portion configured to convert the plurality of the device operating instructions detected by the command interpretation portion into an I/O command for an actual device to issue the I/O command and a host device driver configured to output a device operating instruction for the actual device in accordance with the I/O command issued from the device control portion; and
a virtual machine monitor that mediates between the guest operating system and the host operating system and includes a notification portion configured to notify the device control portion of the host operating system of the plurality of device operating instructions detected by the command interpretation portion.

2. The input/output emulation system for a virtual machine according to claim 1, wherein the programmable logic device includes a field programmable gate array.

3. The input/output emulation system for a virtual machine according to claim 1, wherein the programmable logic device includes a memory based logic.
